(19) United States
(12) Patent Application Publication
(10) Pub. No.: US 2019/0263666 A1
(43) Pub. Date: Aug. 29, 2019

(54) METHOD AND APPARATUS FOR PRODUCING SILICON PARTICLES IN LITHIUM ION RECHARGEABLE BATTERIES

(71) Applicant: Dynatec Engineering AS, Askim (NO)

(72) Inventor: Werner O. FILTVEDT, Tomter (NO)

(73) Assignee: Dynatec Engineering AS, Askim (NO)

(21) Appl. No.: 16/333,846

(22) PCT Filed: Sep. 19, 2017
(86) PCT No.: PCT/NO2017/050235

§ 371 Date: Mar. 15, 2019

(30) Foreign Application Priority Data
Sep. 19, 2016 (NO) 20161490

(51) Int. Cl. C01B 33/027; H01M 4/36; H01M 4/38; H01M 4/587; H01M 4/62; H01M 10/0525

(52) U.S. Cl. CPC C01B 33/027; H01M 4/366; H01M 10/0525; H01M 4/587; H01M 4/625; H01M 4/386

(57) ABSTRACT

Method for producing silicon particles for use as anode material in lithium ion rechargeable batteries, distinctive by the steps: a)optionally, to introduce silicon seed particles and/or lithium seed particles into, or producing silicon or lithium seed particles or inner core material in a rotatable reactor, as a separate optional step or as included in step b), b)to introduce a silicon-containing first reaction gas for CVD into the reactor, setting the reactor in rotation under CVD-conditions; to grow silicon-rich core particles on the seed particles while the reactor is rotated at a rotational speed creating a centripetal acceleration exceeding at least 1000 times the natural acceleration of gravity on said core particles, c)optionally, to introduce a second reaction gas, liquid or material into the reactor of steps a) and b) or a second reactor into which the core particles of step b) have been introduced; to grow a second material of lower silicon contents than the core material, and the second reaction gas, liquid or material is different from the first reaction gas. The invention also provides silicon particles for use as anode material in lithium ion rechargeable batteries, use of a rotating reactor for the method, and a reactor for operating the method.

### FIELD OF THE INVENTION

The present invention relates to rechargeable lithium ion batteries, often termed Li-ion batteries or secondary batteries, and typically used in handheld devices such as cellphones. More specifically, the invention relates to silicon anode material for said batteries, in the form of a method for production, use of a rotating reactor for the method and the particles per se.

### BACKGROUND OF THE INVENTION AND PRIOR ART

Currently, a shift from carbon based anodes to silicon-based anodes for lithium ion rechargeable batteries take place. The reason is the increased capacity achievable. Graphite has a theoretical capacity of about 350-365 mAh/g graphite, which is better than several alternatives. However, silicon has a theoretical capacity of 4200 mAh/g when forming Li₂₂Si₅ and 3580 mAh/g when forming Li₁₅Si₄, which gives a large potential if conversion to silicon based anodes in lithium ion batteries is feasible.

The challenge of utilizing silicon as part of the active material is that silicon undergoes a large volume expansion when intercalating lithium ions. This expansion results in cracking and degradation of the material. Other problems involves formation of electrically disconnected active material, surface reaction between the silicon and the electrolyte forming an inactive brittle layer also referred to as the solid electrolyte interface (SEI). This SEI layer may also crack and peel off the silicon during release of the lithium ions, thereby exposing new silicon surface and the formation of a new inactive SEI layer. The continued SEI formation is both a challenge as it reduces the amount of active silicon material but also since the process consumes parts on the electrolyte. This process will ultimately result in a continued decrease of available active material and reduced capacity of the battery.

The method of thermally decomposing a gaseous silicon precursor to make silicon particles is a known established method, cf. Flagan et al., U.S. Pat. No. 4,642,227. However, utilizing this method results in a silicon powder with a too large size distribution. There have also been numerous attempts to introduce silicon as part of the active material within the anode, using different methods including decomposition of a silicon containing precursor, cf. Lee et al. US2016/0190570 A1. However, without being able to both control the size distribution and the surface chemistry of the particles upon contact with an electrolyte and intercalation and de-intercalation of lithium ions the particles will undergo destructive processes during cycling and ultimately break down.

The most successful attempts so far to produce silicon based anodes for lithium ion batteries are based on making small similar symmetrical silicon geometries, whereby each silicon geometry is filled and emptied at a similar rate in a battery, whereby the tension stress within each silicon geometry does not exceed the tensile strength of the silicon by having the size small. Such geometries have included bottom up grown structures such as silicon nano-particles, nano-wires, nano-tubes as well as different types of top down nano structures such as holey silicon, honeycomb silicon and others. The methods used is typically Plasma Enhanced Chemical Vapor deposition, Atomic Layer Deposition, Sputtering, and top down procedures including various types of etching. Common for all these methods is that the production rate is very slow and the products are very expensive.

Further relevant art is described in the patent publications US 2015/0368113 A1, WO 2014/060535 A1, US 2010/0266902 A1 and patent publications in the names of Amprius and Nexeon, respectively.

A demand exists for silicon anode material for rechargeable lithium ion batteries, resulting in better combination of storage capacity, number of charging cycles and cost for lithium ion batteries A demand also exists for silicon based surface modified nano particles with a narrow size distribution for other applications, such as 3D printed electronics and energy storage devices, printed electronics and the like. The objective of the invention is to meet said demands.

### SUMMARY OF THE INVENTION

The invention provides a method for producing silicon particles for use as anode material in lithium ion rechargeable batteries, distinctive by the steps:

a) optionally, to introduce silicon seed particles and/or lithium seed particles into, or producing silicon or lithium seed particles or inner core material in a rotatable reactor, as a separate optional step or as included in step b),

b) to introduce a silicon-containing first reaction gas for CVD into the reactor, setting the reactor in rotation under CVD-conditions; to grow silicon-rich core particles on the seed particles while the reactor is rotated at a rotational speed creating a centripetal acceleration exceeding at least 1000 times the natural acceleration of gravity on said core particles,

c) optionally, to introduce a second reaction gas, liquid or material into the reactor of steps a) and b) or a second reactor into which the core particles of step b) have been introduced; to grow a second material of lower silicon contents than the core material, and the second reaction gas, liquid or material is different from the first reaction gas.

In many preferable embodiments, the method comprises the further step:

d) to introduce a third reaction gas, liquid or material into the reactor of steps a)-c) or a second or third reactor into which the particles of step c) have been introduced; to grow a third material of lower silicon contents than the second material on the particles of step c), the third reaction gas, liquid or material is different from the second reaction gas, liquid or material.

Preferably, one, or both of steps c) and d) takes place under CVD-conditions while the reactor rotates.

Preferably, the rotation in step b) is creating a centripetal acceleration exceeding at least 2000 times g, where g is the natural acceleration of gravity, on said core particles, more preferably exceeding at least 3000 g, 4000 g or 5000 g, more preferably at least 10 000 g, even more preferably at least 25 000 g or 50 000 g or 100 000 g.

Preferably, the method steps are performed under inert conditions, meaning that the resulting particles are not subject to unintentional reactions by oxygen or other gases or materials. This is preferably achieved by using the reaction gas or material for each step if particles are to be introduced from one reactor to another, or retaining the reaction gas or material, or using an inert gas such as nitrogen, for shielding and/or as transport medium.

For some embodiments, it is preferable to have the particle surfaces saturated with hydrogen, dependent on subsequent steps. To retain the surface hydrogen, it is preferable to lower the temperature to below 300° C. and keep the particles in a hydrogen atmosphere. If it is not preferable to retain hydrogen on the particle surface, it is preferable to increase the temperature to above 700° C. in nitrogen or for example argon, to increase the hydrogen desorption rate.

If only the silicon-rich core particles are produced, said core particles are preferably stored and transported in an inert medium to avoid destructive passivation or degradation thereof. Also with the optional second material, and also with the optional third material, the particles are preferably stored and transported in an inert medium to avoid destructive passivation or degradation thereof, thereby increasing shelf life and service life. Preferably, the method and the particles includes at least the step for growing the second material and the second material, respectively, providing particles that can be supplied directly to the battery producer.

Preferably, the method of the invention comprises the step to introduce lithium seed particles into, or producing lithium seed particles or lithium inner core material in a rotatable reactor. The lithium inner core material can be distinct lithium inner core particles or of gradually decreasing lithium concentration from an inner core of highest lithium concentration. The reasoning for this preferable feature of the method of the invention, is that the first time the lithium goes out of the silicon particles of the invention void structures are thereby formed, which void structures will prevent cracking at later recharging cycles.

The second material and when present, the third material, protect the produced particles from degradation, increasing the service life, such as number of charging-recharging cycles, and shelf life of the produced particles.

Preferably, the first reaction gas comprises one or more of SiH₄, Si₂H₆, SiHCl₃ and higher order silanes and chlorosilanes, and any combinations thereof.

Preferably, the second reaction gas, liquid or material comprises C, O or N in combination with silicon, such as SiOₓ, SiCₓ, SiNₓ; amorphous carbon, graphite, low-crystalline carbon or low range order graphene structures; C, O and N containing materials combined or replaced with a metal capable of alloying with lithium, for example Ge, GeOₓ, In, Bi, Mg, Ag, Zn, ZnOₓ, FeOₓ, SnOₓ and TiOₓ or alloys or composite alloys combining several metals in a structured geometrical pattern and/or in radially distributed layers outside the silicon core particle, alone or in any combination.

For SiOₓ reaction gas, x can have any naturally occurring value. However, preferably x is in the range [0.5-1], that is from and including 0.5 to and including 1.

The transition between steps b) and c) is discrete or gradual, or any transition in between. Preferably, said transition is in substance linear to the inverse mean diameter or radius of the particles grown, and the transition between steps c) and d) is discrete or gradual, or any transition in between, preferably in substance linear to the inverse mean diameter or radius of the particles grown.

In a preferable embodiment, the second and/or third reaction gas, liquid or material of step d) comprises lithium. The resulting particles, comprising lithium, may provide increased battery service life by avoiding premature reaction with the electrolyte.

The invention also provides use of at least one rotatable reactor for the method of the invention for producing silicon particles for use as anode material in lithium ion rechargeable batteries.

The present invention also provides silicon particles for use as anode material in lithium ion rechargeable batteries, distinctive in that the particles comprises
a in substance spherical silicon-rich core, with or without a lithium inner core material introduced as seed particles or produced in the rotatable reactor, said in substance spherical silicon-rich core has mean diameter or D50 in the range 5-750 nm, preferably below 100 nm, and a standard deviation of less than 50% of the absolute value of D50,
an optional second material of lower silicon contents than the core, preferably as a in substance spherical shell around the core, and
an optional third material of lower silicon contents than the second material around the second material, preferably in substance as a spherical shell around the second material.

Preferably, the silicon rich core particles have a purity above 99% by weight of silicon, more preferably at least a purity of 99.5% by weight of silicon.

Preferably, lowering of silicon contents is discrete or gradual, or any transition in between. Preferably, said lowering is in substance linear to the inverse mean diameter or radius of the particles, in direction radial from the core through the second material and further through the third material if present.

The mean diameter range of the in substance spherical silicon core, is 5-750 nm, more preferably 40-200 nm, 10-150 nm, 30-270 nm, 10-90 nm, 20-200 nm, 50-750 nm, 10-150 nm, 50-670 nm, 10-250 nm, more preferably 5-50 nm, with upper and lower limits freely chosen from and within the ranges above. The mean core diameter is preferably below 100 nm, such as about 92 nm. The core particle sizes are measured by standardized methods; preferably laser diffraction according to ISO 13320 (2009), more details are found at the link: http://www.malvern.com/en/products/technology/laser-diffraction/

The overall silicon particle size, including the second layer and optionally the third layer, has D50 and mean diameter preferably about 1-100 nm larger, more preferably 1-50 nm larger, than the silicon rich core particles. The standard deviation of overall particle size mean diameter preferably is identical or similar to as for the core particles.

In the context of the present invention, the term diameter refers to the diameter of a spherical particle or the longest length or dimension in a more or less sphere-shaped particle.

In the context of the present invention, core particles are termed silicon core particles, primary particles, first particles and other terms, understandable from the text.

As well known in the art, D50 means that 50% of the particles are smaller and 50% of the particles are larger than the D50 mean size.

For a D50 of for example 100 nm, the standard deviation shall be less than 50 nm.

For silicon particles of the invention, be it silicon core particles or particles with silicon core and second material or particles with silicon core, second material and third material, the standard deviation is less than 50% of the absolute value of D50. For said particles, said standard deviation preferably is less than 40%, more preferably less than 30%, even more preferably less than 25%, 20% or 15%.

The term precursor may term the reaction gas or reaction material of steps a), b), c) or d), pure or mixed as explained, as understandable from the text.

Preferably, the particles of the invention comprises a lithium inner core material, introduced as seed particles or produced in the rotatable reactor. The lithium inner core material can be distinct lithium inner core particles or of gradually decreasing lithium concentration from an inner core of highest lithium concentration. The reasoning for this preferable feature of the particles of the invention, is that the first time the lithium goes out of the silicon particles of the invention void structures are thereby formed, which void structures will prevent cracking at later recharging cycles.

Preferably, the particles are produced by the method of the invention.

The particles are of a smaller core size and narrower core size distribution and/or finished silicon particle size distribution, either for a specific cost than comparable particles produced by other methods or the particles are novel per se.

The silicon particles of the invention may be part of structures, which structures comprising silicon particles of the invention are embodiments of the present invention. Said structures can be anodes for rechargeable lithium ion batteries, modules or elements for anodes for lithium ion rechargeable batteries or the finished lithium ion batteries. In addition, said structures can be 3D printed structures, printed electronic circuits and other battery types for which surface-modified monodisperse particles of the invention are beneficial.

The invention also provides a reactor for operating the method of the invention, comprising a reactor chamber, an inlet and an outlet or a combined inlet and outlet, and means to heat the reactor chamber to at least 580° C., distinctive in comprising a motor arranged to rotate the reactor at rpm to provide at least a centripetal acceleration of 1000 g on the produced silicon particles, where g is the natural acceleration of gravity, and the inlets and outlet are rotatable at said rpm without leakage at pressure to above 1 bar and temperature of at least 580° C.

### FIGURES

FIG. 1. Silicon particles of the invention, comprising silicon core and a second and third material

FIG. 2. Method and reactor layout for production of the said material, according to the invention.

FIG. 3. Method and reactor layout for multi-stage particle formation, according to the invention.

FIG. 4. SEM image of silicon cores of particles produced by centrifuge CVD, according to the invention.

FIG. 5. Particle size distribution analysis by laser scattering of core silicon particles produced by centrifuge CVD, according to the invention.

### DETAILED DESCRIPTION

The reactor is designed to specifically tailor the growth of the particles by the fluid mechanical and thermal field as well as the chemical composition of the incoming gases. This tailored growth regime results in a narrow distribution in size and geometry. The second stage of the growth is preferably to introduce a second gas, liquid or solid matter in order to produce a composite structure or structure consisting of composite particles to obtain a complete active anode material ready to be adhered to a conductive metallic foil and installed into a battery. The first stage of the particle growth, step b) growing the silicon core, takes place in a reactor where the layout of the reactor is in the form of a centrifuge in order to be able to introduce large centripetal forces without having large velocity gradients at the wall. The result is a controlled high centripetal force field without too high turbulence intensity, providing narrower size and geometry distribution of the grown particles, which is discussed below.

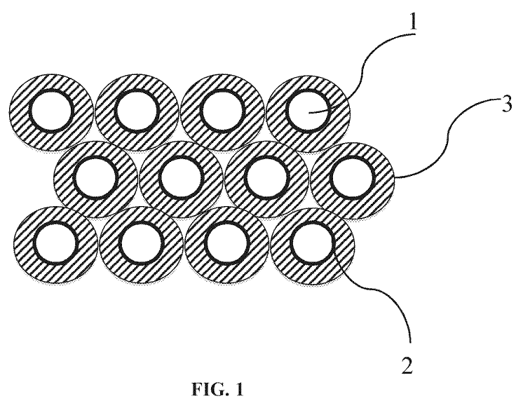

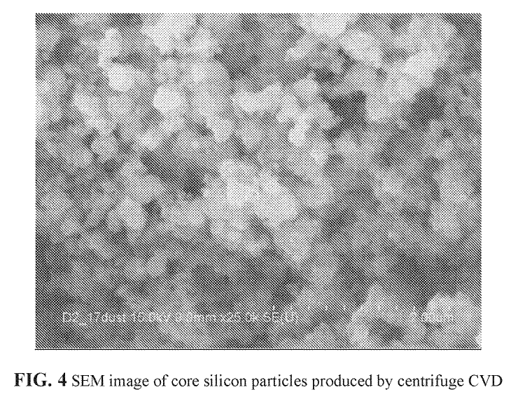

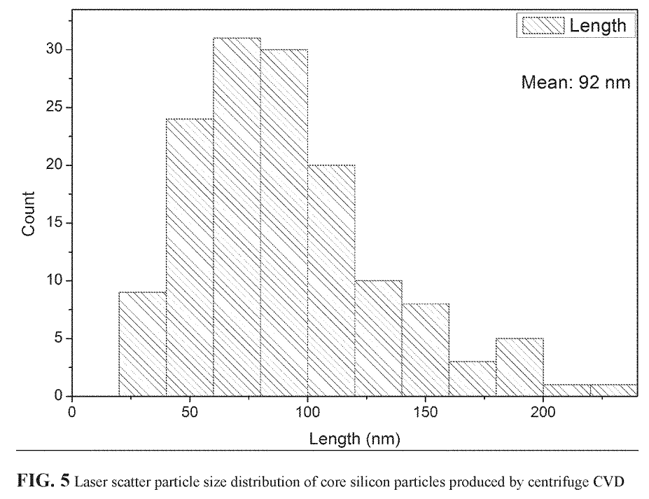

Reference is made to FIG. 1, illustrating silicon particles of the invention. In one embodiment of the solution the material comprises spherical silicon core particles as nano particles (1). The silicon core particles may be pure crystalline or amorphous silicon or a combination of amorphous and crystalline silicon, alternatively another silicon containing material including but not limited to SiOₓ, SiCₓ, SiNₓincluding but not limited to SiC, SiO₂ and α-Si₃N₄. The particles are grown from decomposition of one or several gaseous silicon containing precursor in a centrifuge reactor and are thus of a narrow size distribution, see FIG. 4 and FIG. 5. In one embodiment the core particles (1) comprises amorphous or partly amorphous silicon by hydrogenation of the silicon lattice silicon in a size distribution between 10 and 300 nm, preferably between 50 and 200 nm. In one embodiment the core particles (1) comprises crystalline or partly amorphous silicon by hydrogenation of the silicon lattice silicon in a size distribution between 10 and 300 nm, preferably between 50 and 200 nm.

Upon the primary silicon rich core particles a second material (2) comprising carbon in the form of graphite, graphene, amorphous carbon, including but not restricted to low range order crystalline carbon including but not restricted to carbon deposited from a gaseous precursor such as acetylene or methane. The second material may comprise SiOₓ, SiCₓ, SiNₓincluding but not limited to SiC, SiO₂ and α-Si₃N₄ in combination or not with a metal capable of alloying with silicon including but not limited to Ge, GeOₓ, Mg, Ag, Zn, ZnOₓ, Fe, FeOₓ, SnOₓ, TiOₓ, Ni, In, B, Sn, Ti, Al, Ni, Sb and Bi including but not limited to NiSi, CaSi₂, Mg₂Si, FeSi, FeSi₂, CoSi₂, Al₂O₃, TiO₂, CO₃O₄, B₄C and NiSi₂, alone or in any combination. The second material (2) may comprise carbon in the form of graphene deposited from acetyelene or methane onto a hydrogensaturated silicon surface. The graphene may or may not be n-doped by phosphorous or nitrogen or p-doped by beryllium, boron, aluminum, or gallium depending on the layout and composition of the anode. The second material (2) may comprise SiC that may be n-doped by phosphorous or nitrogen or p-doped by beryllium, boron, aluminum, or gallium depending on the desired layout and composition of the anode. Preferably n-doped with the current state of the art anode and battery layouts. The second material may be formed by decomposing a carbon containing decomposable precursor including but not limited to acetylene, methane or propane together with a silicon containing precursor including but not limited to SiH₄ or Si₂H₆ and subsequently subject the surface to a decomposable precursor containing the dopant and heat the dopant containing precursor until decomposition. Such a precursor may comprise PH₃, NH₃ or B₂H₆, as well as other decomposable precursors. If deposition of the second material is performed in a second chamber this chamber may have a substantially different operation conditions from the first chamber including but not limited to higher temperature, lower pressure and/or have radio-frequency plasma-enhanced deposition (PECVD), microwave PECVD or electron-cyclotron resonance PECVD in order to chose from a wider selection of possible dopant containing precursors decomposable within the operation parameter domain of the reactor.

Reference is made to FIG. 1. In one embodiment a third material (3) is added outside the second material (2). The third material may be different in composition and/or structure than the second material including but not restricted to carbon deposited from a gaseous precursor such as acetylene or methane. The third material may comprise of carbon in the form of graphite, graphene, amorphous carbon, including but not restricted to low range order crystalline carbon in combination with a metal capable of alloying with silicon including but not limited to Ge, GeOₓ, In, Bi, Mg, Ag, Zn, ZnOₓ, FeOₓ, SnOₓ and TiOₓ, alone or in any combination. In one embodiment the metal added in the second and/or third material may be deposited by decomposition of a metal organic framework in the form of a gas or liquid under the relevant process conditions. If a liquid precursor is utilized it may be fed by means of droplets carried by an inert gas into the decomposition chamber. In such a process it would be important to keep the temperature of the process chamber sufficiently low in order to prevent premature decomposition of the precursor and let the hydrogenated silicon surface act as a catalyst for the metal organic gas in order to promote a uniform deposition. It would also be important to use a transport tube and process chamber that is not catalytic to the decomposition reaction of the metal organic substance in order to limit premature decomposition and production of metal particles within the reactor.

In one preferred embodiment the first material (1) is a silicon containing material such as amorphous Si or α-Si₃N₄, the second material (2) is C primarily in the form of graphene and the third material (3) is porous flexible carbon and silicon containing solid such as C₂H₆Si produced from reaction of a carbon containing gaseous precursor such as CH₄ or C₂H₂ and a silicon containing precursor such as SiH₄ at the outside of the second material (2).

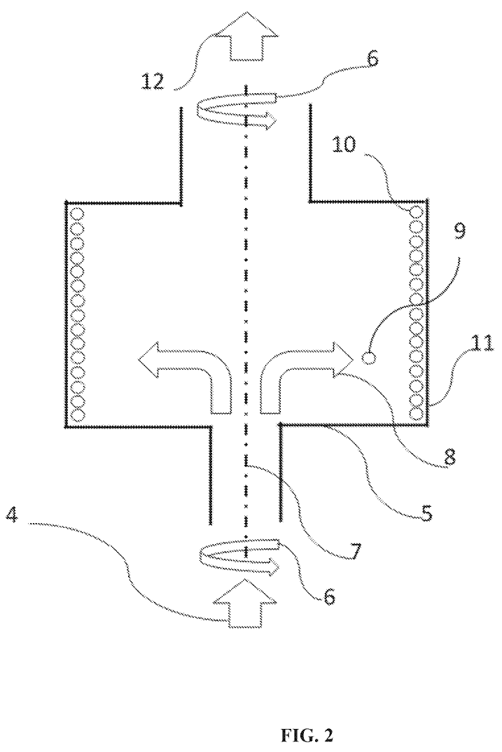

Reference is made to FIG. 2. In one embodiment the method of the invention comprises introducing an incoming precursor (4) gas containing silicon including but not limited to SiH₄, Si₂H₆, SiHCl₃. In a preferred embodiment SiH₄ is supplied to a reactor chamber (5) rotating (6) about an axis (7). The rotation will generate a centripetal acceleration and thus the gas will experience an artificial g-field, more precisely a centripetal acceleration, forcing the gas towards the wall. The artificial g-field is in the order of 1000 to 100 000 times the earth gravity G, also termed g. In a preferred embodiment 1000 to 20 000 times the earth gravity G. The chamber is heated by a heat source either outside the chamber, by induction, by any irradiative light source or any other electromagnetic source not shown. The gas will upon entering the reactor chamber experience the centripetal forces due to the rotation of the chamber and be forced towards the wall (8). Upon being heated to the decomposition temperature the gas decomposes and forms solid particles (9). The shape of the thermal boundary layer at the wall will be a function of the wall temperature, the incoming gas temperature, the incoming gas velocity, the incoming gas chemical composition, the geometry of the reactor chamber in particular the diameter as well as the means by which heat is supplied compared to how efficient the different gaseous and solid species is heated by the combination of heat sources. The solid particles then subsequently functions as a nucleation surface for further surface reaction of the precursor and thus scavenges unreacted precursor gas as it travels through the reactor volume. It is known that low order silanes will be transparent to infrared light while amorphous silicon particles have good absorbance to these wavelengths. This selective adsorption rate may be used to control the growth sequence and ultimately the particle size distribution, by using infrared light as heat source inside the reactor chamber, which represents preferable embodiments of the invention. The centripetal forces each particle experience will be a function of its mass while the fluid mechanical drag will be a function of the cross-sectional area of the particle. Since the particles grown are largely spherical these two functions will both be a function of the particle radius, but the centripetal force will increase with the radius to the power of three while the cross-sectional area will increase to the power of two. For a given set of centripetal force field as a result of a given reactor diameter, geometry and rotational speed and a fluid mechanical field as a result of gas composition, incoming gas velocity, flux and location of supply nozzles as well as the thermal gradients in the reactor volume and its influence on the fluid mechanics and kinetics of the reactions involved will result in a selective growth of a certain sized particles. When the centripetal force surpasses the fluid mechanical drag will happen at the same radius for each particle and thus there will be a selective mechanism that moves the heavy particles towards the wall quickly as they surpass a certain diameter. For particles that grow faster this selective mechanism will sort them out earlier while particles that grow slower are allowed to linger longer in the reactor and scavenge more precursor gas. By utilizing a rotating chamber in combination with optimized process conditions it is thus possible to grow particles with a substantially narrower size distribution than for other types of reactors decomposing silicon-containing precursors. Utilizing a rotating reactor chamber to control the particle size is a method where each particle is weighed and treated independently to compensate for different growth speed in order to promote a narrower size distribution. It is thus possible to achieve a narrow size distribution even when going to higher precursor concentrations and reactor operating pressure, which is directly linked to the production rate of the reactor. After formation and growth the particles accumulates (10) at the wall (11). Hydrogen, and depending on the process conditions unreacted precursor gas and small particles exits the reactor at the top (12). Depending on the parameters chosen in terms of rotational speed (6), diameter of the reactor, partial pressure of the precursor gas in the incoming gas (4) as well as the temperature distribution in the reactor volume it is possible to optimize for large accumulation of particles at the wall (10) or large concentration of small particles in the exhaust (12). Common for both these embodiments of the invention is that centripetal forces are used to control the process and maintain a narrow particle size distribution.

After the core silicon particles have been formed they may either be further processed in the same chamber or they may be harvested and processed in a second chamber. In an embodiment where the different stages of the particle growth are performed in different reactors the particle harvest from the first reactor may either be from accumulation of particles at the wall (10) or retrieved from the exiting gas flow (12), each of which options represents embodiments of the invention.

Further reference is made to FIG. 2. In one embodiment of the invention the three stages of the method is carried out in the same physical reactor chamber. First the silicon containing precursor (4) is fed into the rotating reactor chamber (5). The gas is then heated until decomposition during rotation and the silicon powder is accumulated (10) at the wall (11). The flow of the silicon containing precursor is stopped and replaced with a second flow of a second precursor (4). Although the illustration shows the same inlet for these gases this in only one possible embodiment of the solution. Several inlet nozzles at fixed positions or moving relatively to each other in time are other possible embodiments. In a preferred embodiment the precursor carrying the second material has a decomposition temperature above the chamber temperature of the reactor but the hydrogenated surface of the silicon particles acts as a catalyst on the decomposition and the result is that the second material is deposited onto the surface of the silicon particles with a minimal production of new particles from gaseous decomposition of the second precursor. The second precursor may comprise C, O, N and deposit a material such as SiCₓ, SiOₓ, SiNₓ, including but not limited to SiC, SiO₂, SiO, Si₂O and α-Si₃N₄. The second material may also comprise one or several metals capable of alloying with silicon including but not limited to Ge, GeOₓ, In, Bi, Mg, Ag, Zn, ZnOₓ, FeOₓ, SnOₓ, TiOₓ, Ni, In and Bi including but not limited to NiSi, CaSi₂, Mg₂Si, FeSi, FeSi₂, CoSi₂, and NiSi₂. The second material may also be n or p doped. In one embodiment of the solution the second material comprises SiC n-doped with nitrogen by decomposition of NH₃. After deposition of the second material at the surface of the silicon core particles the particles are harvested. The harvest method is not shown in the illustration, but may be mechanical, by vacuum or any other means. It will be important to harvest frequently to avoid surface growth on the core particles after they have accumulated (10) at the wall (11) as this will widen the particle size distribution. Reference is made to FIG. 2. In some embodiments a third material different from the first and second material is fed (4) into the reactor (5) after the production of the first and deposition of the second material. The third precursor may comprise C, O, N, and deposit a material such as SiCₓ, SiOₓ, SiNₓ, including but not limited to SiC, SiO₂, SiO, Si₂O and α-Si₃N₄ and may comprise a metal capable of alloying with silicon such as Ge, GeOₓ, In, Bi, Mg, Ag, Zn, ZnOₓ, FeOₓ, SnOₓ, TiOₓ, Ni, In and Bi including but not limited to NiSi, CaSi₂, Mg₂Si, FeSi, FeSi₂, CoSi₂, and NiSi₂ and is different from the second material in structure and/or chemical composition, alone or in any combination.

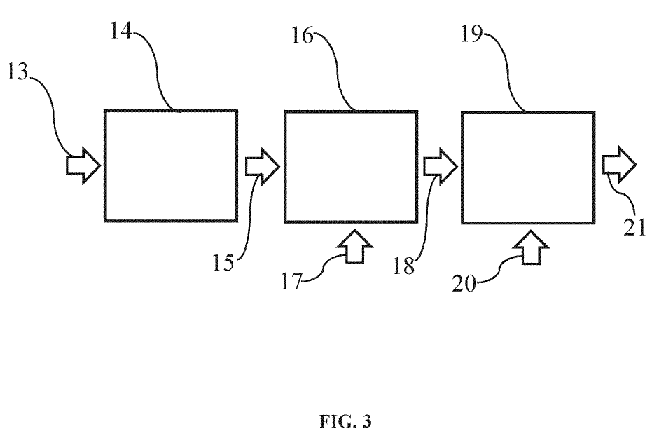

Reference is made to FIG. 3. In one embodiment of the solution the three processes are carried out in three process chambers (14), (16), (19). First the silicon containing precursor (13) is fed into a rotating heated process chamber (14) to produce the primary core particles, also termed the silicon-rich core particles or core particles. Reference is made to FIG. 2. The primary core particles are then either harvested from the wall (10) or retrieved from entrainment in the exiting gas flow (12) depending on the process conditions and the desired properties of the produced material.

Reference is made to FIG. 3. After the silicon particles are formed they are transported entrained in a non reacting gas flow (15) to a second chamber (16). If the catalytic effect of the hydrogenated particle surface is wanted for the decomposition reaction of the second precursor it is important to keep the hydrogen partial pressure in the entrainment gas high since the hydrogen desorption rate is inversely proportional to the hydrogen partial pressure outside the hydrogenated surface. The hydrogen desorption rate is also temperature dependent so it will be advantageous to keep the temperature of the transporting gas between the first (14) and second (16) process chamber lower. When the particles enter the second chamber a second decomposable precursor is fed into the same chamber (17) and when the second gas reaches the particle surface it deposits a second material. The second chamber may be both a rotating or non rotating chamber depending on the precursor gas chosen (17) and the growth rate of the second material under the conditions within the second reactor chamber (16). After the deposition of the second material the particles are transferred (18) to a third reaction chamber (19) where a third reaction gas is inserted (20) to deposit a third material. The third reactor chamber may be a rotating or non rotating chamber depending on the properties of the precursor chosen and the conditions within the third reaction chamber. After a third material is deposited onto the particles they comprises a first silicon containing core particle a second layer of a second material and a third layer of a third material. They are then harvested from the third reactor chamber either entrained in the exiting gas flow or from one or several collection surfaces within the third reactor chamber (21).

Reference is made to FIG. 3. One embodiment of the solution is that the three processes (14), (16) and (19) are different types of processes. First, the silicon containing precursor (13) is fed into a rotating heated process chamber (14) to produce the primary core particles comprising a silicon containing material including but not limited to amorphous hydrogenated silicon. The particles are then retrieved and transported (15) to a second low pressure PECVD chamber (16) where a second carbon containing precursor (17) including but not limited to acetylene, methane, propane or propylene is introduced and decomposed forming a second carbon containing material on the particles 1-10 nm in thickness, preferably 1-5 nm. The particles are then retrieved and transported (18) to a third process (19). The particles may be mixed with a carbon containing precursor in a fluid solution (18) through a wet chemical process where the third material is deposited onto the particles in a solution. Such a carbon containing precursor may include but is not limited to sulfonyldiphenol, triethylamine, maltose, polyvinyl chloride, or sucrose. The particles may then be harvested and heat treated in the third process chamber (19) and the carbon containing precursor is then reduced to a carbon containing solid material. Reference is made to FIG. 3. One further embodiment of the solution is that the three processes (14), (16), (19) are different types of processes. First the silicon containing precursor (13) is fed into a rotating heated process chamber (14) to produce the primary core particles comprising a silicon containing material including but not limited to amorphous hydrogenated silicon. The particles are then retrieved and transported (15) to a second low pressure PECVD chamber (16) where a second carbon containing precursor (17) including but not limited to acetylene, methane, propane or propylene is introduced and decomposed forming a second carbon containing material on the particles 1-10 nm in thickness, preferably 1-5 nm. The particles are then retrieved and transported (18) to a third process (19). The particles are mixed with a fluid carbon containing precursor on the way to the third process chamber (18) and the carbon containing precursor may be thermally reduced within the third reactor chamber (19). These carbon containing precursors may also be added directly to the chamber (20) depending on the layout of the reactor and the process flow of the chamber. Examples of such reducible carbon containing precursors includes but is not limited to benzene or toluene.

FIG. 4 is an image taken from a scanning electron microscope, SEM, showing silicon-rich core particles according to the invention, which particles have been produced according to the invention. The particles are more spherical in shape than for particles produced by competitive methods. The particles also have a narrower size distribution than particles produced by other methods. Particle production in the rotating reactor provides reduced tendency to creation of larger agglomerations than in a free space reactor, natural size sorting due to effects of the rotation and the resulting centripetal acceleration field. In addition, an optional step of the method of the invention contributes; namely physical removal of the largest particles produced at frequent intervals, for example removal of the largest particles every 30 second.

FIG. 5 is a laser diffraction distribution of particle sizes, for particles of the invention, produced by the method of the invention. The number of particles are designated on the y-axis, while the diameter, here termed length, is designated on the x-axis. The mean diameter, or length value, is 92 nm, with a standard deviation of 43 nm.

### EXAMPLE 1

SiH₄ is supplied to a rotational reactor maintaining an artificial gravity field of 10 000 G. The chamber is heated to 580° C. and the gas decomposes and produced silicon particles of 10-150 nm. The primary silicon particles are retrieved from the chamber and fed to a second chamber rotating at 1000 G maintaining a temperature of 640° C. In the second chamber CH₄ is supplied together with SiH₄ and a second layer of SiC of 0-5 nm thickness is deposited onto the primary particles.

### EXAMPLE 2

Si₂H₆ is supplied to a rotational reactor maintaining an artificial gravity field of 8 000 G. The chamber is heated to 650° C. and the gas decomposes and produced silicon particles of 30-270 nm. The primary silicon particles are retrieved from the chamber and fed to a second non rotating chamber at 30° C. with 0.5% O₂ in H₂ and a layer of SiOₓ is formed at the surface of the particles of 1 to 5 nm thickness. The particles are then harvested and fed into a third non rotating chamber holding 680° C. In the third chamber CH₄ is supplied and a third layer of crystalline carbon of 0-5 nm thickness is deposited onto the particles.

### EXAMPLE 3

SiH₄ is supplied to a rotational reactor maintaining an artificial gravity field of 10 000 G. The chamber is heated to 690° C. and the gas decomposes and produced silicon particles of 10-90 nm. The primary silicon particles are retrieved from the chamber and fed to a second chamber rotating at 1000 G maintaining a temperature of 720° C. In the second chamber CH₄ is supplied and a second layer of crystalline carbon of 5-15 nm thickness is deposited onto the primary particles.

### EXAMPLE 4

50 atm % SiH₄ in 50 atm % H₂ is supplied to a rotational reactor maintaining an artificial gravity field of 10 000 G. The chamber is heated to 550° C. and the gas decomposes and produced silicon particles of 20-200 nm. The primary silicon particles are retrieved from the chamber and fed to a second non rotating chamber at a temperature of 530° C. In the second chamber 10 atm % CH₄ is supplied together with 10 atm % SiH₄ and 80 atm % H₂ and a layer of vinylsilane C₂H₆Si of a thickness of 1-10 nm is deposited onto the particles.

### EXAMPLE 5

SiH₄ is supplied to a rotational reactor maintaining an artificial gravity field of 1 000 G. The chamber is heated to 550° C. and the gas decomposes and produced silicon particles of 50-750 nm. The primary silicon particles are retrieved from the chamber and fed to a second non rotating chamber at a temperature of 480° C. In the second chamber titanium isopropoxide, Ti(OPrⁱ)₄is supplied and a layer og TiOₓ is deposited onto the particles in a thickness of 0-3 nm. The particles are then retrieved and fed into a third rotating chamber maintaining a temperature of 520° C. and an artificial gravity field of 3000 G. In the third reactor chamber C₂H₂ is supplied and a layer of crystalline carbon of a thickness of 5-25 nm is deposited onto the particles.

### EXAMPLE 6

40 atm % SiH_{4, 30} atm % NH₃ and 30 atm % H₂ is supplied to a rotational reactor maintaining an artificial gravity field of 10 000 G. The chamber is heated to 620° C. and the gas decomposes and produces α-Si₃N₄ particles of 10-150 nm. The α-Si₃N₄ particles are harvested from the chamber and mixed with 1 atm % 2,4′-sulfonyldiphenol and 1 atm % Ni particles of a particle size of 1-8 nm dispersed in a liquid solution of 20 atm % tetrahydrofuran and 68 atm % ethanol. The particles are then filtrated out of the solution and dried in 60° C. N₂ for 2 hrs. The core particles with deposited carbon and Ni particles is then heat treated in a fluidized bed chamber with N₂ at 720° C. for 3 hours and harvested. The carbon and Ni coating layer will be of 5-20 nm thickness depending on several factors including the mixing process and the fluid mechanical properties within the FBR. If the fluidization intensity is too high some of the carbon will peel off and become independent carbon particles.

### EXAMPLE 7

Concentration of the precursor in the in-feed gas, the temperature of the reactor chamber, the pressure, residence time within the reactor, concentration of catalytic gases, liquids or solids as well as the spatial gradients of these values will all influence the growth and hence the particle size distribution. However, by utilizing rotational velocity to control the size distribution it is possible to maintain a favorable size distribution even at high production rates and low power consumption.

Given 80 atm % SiH₄ in 20 atm % H₂ in the feed gas into a reactor temperature of 650° C., 1 bar pressure, at an average reactor residence time of 4 seconds the influence of rotational velocity on particle size distribution is substantial. The table is based on a non-catalytic reactor chamber. If the reactor chamber is catalytic to the chemical process the particle onset temperature will be lower and shift the particle size distribution to lower sizes.

| Centripetal acceleration | Particle size distribution |
|---|---|
| 1000 G | 50-670 nm |
| 10 000 G | 10-250 nm |
| 100 000 G | 5-50 nm |

A reactor of 100 mm diameter reactor rotating at 13 400 rpm will have a centripetal acceleration of about 10 000 G and under the conditions given in this example have a particle size distribution of 10-250 nm. The centripetal acceleration can be calculated from the square of the velocity, in m/s, divided on the reactor radius, in meter.

With the rotating reactor and method of the invention, the combination of high production rate, narrow size distribution, small sized particles and in substance spherical particles, are provided, which results in lower cost. The rotation allows higher gas pressures or precursor concentrations whilst avoiding unwanted side-reactions and effects, compared to other methods and reactors. The method of the invention may comprise any step or feature as here described or illustrated, in any operative combination, each such combination is an embodiment of the invention. The reactor of the invention may comprise any step or feature as here described or illustrated, in any operative combination, each such combination is an embodiment of the invention.

1. A method for producing silicon particles for use as anode material in lithium ion rechargeable batteries, the method comprising:
a) optionally, to introduce silicon seed particles and/or lithium seed particles into, or producing silicon or lithium seed particles or inner core material in a rotatable reactor, as a separate optional step or as included in step b),
b) to introduce a silicon-containing first reaction gas for CVD into the reactor, setting the reactor in rotation under CVD-conditions; to grow silicon-rich core particles on the seed particles while the reactor is rotated at a rotational speed creating a centripetal acceleration exceeding at least 1000 times the natural acceleration of gravity on the core particles,
c) optionally, to introduce a second reaction gas, liquid or material into the reactor of steps a) and b) or a second reactor into which the core particles of step b) have been introduced; to grow a second material of lower silicon contents than the core material, and the second reaction gas, liquid or material is different from the first reaction gas.

2. The method according to claim 1, comprising:
d) to introduce a third reaction gas, liquid or material into the reactor of steps a)-c) or a second or third reactor into which the particles of step c) have been introduced; to grow a third material of lower silicon contents than the second material on the particles of step c), the third reaction gas, liquid or material is different from the second reaction gas, liquid or material.

3. The method according to claim 1, wherein the rotation in step b) creates a centripetal acceleration exceeding at least 2000 times g, where g is the natural acceleration of gravity, on the core particles, more preferably at least 5000 g, more preferably at least 10 000 g, even more preferably at least 25 000 g or 50 000 g or 100 000 g.

4. The method according to claim 1, wherein the first reaction gas comprises one or more of SiH₄, Si₂H₆, SiHCl₃ and higher order silanes and chlorosilanes; and the second reaction gas, liquid or material comprises C, O or N in combination with silicon, such as SiOₓ, SiCₓ, SiNₓ; amorphous carbon, graphite, low-crystalline carbon or low range order graphene structures; C, O and N containing materials combined or replaced with a metal capable of alloying with lithium.

5. The method according to claim 1, wherein the transition between steps b) and c) is discrete or gradual, or any transition in between, preferably in substance linear to the inverse mean diameter of the particles grown, and the transition between steps c) and d) is discrete or gradual, or any transition in between, preferably in substance linear to the inverse mean diameter of the particles grown.

6. (canceled)

7. Silicon particles for use as anode material in lithium ion rechargeable batteries, the silicon particles comprising:
an in substance spherical silicon-rich core, with or without a lithium inner core material introduced as seed particles or produced in the rotatable reactor, the in substance spherical silicon-rich core has mean diameter or D50 in the range 5-750 nm, preferably below 100 nm, and a standard deviation of less than 50% of the absolute value of D50,
an optional second material of lower silicon contents than the core, preferably as an in substance spherical shell around the core, and
an optional third material of lower silicon contents than the second material around the second material, preferably in substance as a spherical shell around the second material.

8. The silicon particles according to claim 7, wherein the silicon rich core particles have a purity above 99% by weight of silicon, more preferably at least a purity of 99.5% by weight of silicon.

9. The silicon particles according to claim 7, wherein the lowering of silicon contents in the second and third materials are discrete or gradual, or any transition in between.

10. The silicon particles according to claim 7, wherein the particles are produced by claim 1.
